(19) United States
(12) Patent Application Publication
(10) Pub. No.: US 2026/0140317 A1
(43) Pub. Date: May 21, 2026

(54) PHOTONIC DEVICES AND SYSTEMS INCLUDING PHOTONIC DEVICES

(71) Applicant: Infineon Technologies Austria AG, Villach (AT)

(72) Inventors: Alexander Zesar, Villach (AT); Clemens Rössler, Villach (AT); Silke Katharina Auchter, Villach (AT); Fabian Laurent, Villach (AT); Yves Colombe, Villach (AT); Klemens Karl Heinrich Schüppert, Goritschach (AT); Sofia Cano Castro, Villach (AT); Max Glantschnig, Villach (AT); Michael Dieter Josef Pfeifer, Klagenfurt am Wörthersee (AT); Matthias Brandl, Kirchseeon (DE)

(21) Appl. No.: 19/390,862

(22) Filed: Nov. 17, 2025

(30) Foreign Application Priority Data
Nov. 20, 2024 (DE) 102024134022.3

(51) Int. Cl. G02B 6/293; G02B 6/35; G02B 6/36; G02B 6/42; G21K 1/00

(52) U.S. Cl. CPC G02B 6/29305; G02B 6/3588; G02B 6/3636; G02B 6/368; G02B 6/4277; G21K 1/30

(57) ABSTRACT

A photonic device includes a first interface configured to couple a plurality of first waveguides of the photonic device to a plurality of waveguides of a light source, and a second interface configured to couple a plurality of second waveguides of the photonic device to a plurality of waveguides of an atom trap device. A number of the plurality of first waveguides is smaller than a number of the plurality of second waveguides. A first pitch of the plurality of first waveguides is greater than a second pitch of the plurality of second waveguides.

### TECHNICAL FIELD

The present disclosure relates to photonic devices and system including photonic devices.

### BACKGROUND

Atom trap devices need to be scaled up to a large number of trapped atoms to enable applications of practical interest. Such scaling may require, inter alia, appropriate integration of photonics for laser light delivery. In some applications, at least four laser beams per atom trapping site may be required in order to control potentially hundreds of atoms independently. As atom traps are scaled up to larger dimensions, an increasing number of laser beams poses a major challenge in terms of optical access to the atom trap device. In this context, it may be desirable to provide solutions that allow a straightforward and easy scaling of atom trap devices in order to increase the number of trapped atoms, while overcoming the issues mentioned above.

### SUMMARY

An aspect of the present disclosure relates to a photonic device. The photonic device comprises a first interface configured to couple a plurality of first waveguides of the photonic device to a plurality of waveguides of a light source and a second interface configured to couple a plurality of second waveguides of the photonic device to a plurality of waveguides of an atom trap device. A number of the plurality of first waveguides is smaller than a number of the plurality of second waveguides. A first pitch of the plurality of first waveguides is greater than a second pitch of the plurality of second waveguides.

A further aspect of the present disclosure relates to a system. The system comprises a light source comprising a plurality of waveguides, an atom trap device comprising a plurality of waveguides, and a first photonic device. The first photonic device comprises a first interface configured to couple a plurality of first waveguides of the photonic device to the plurality of waveguides of the light source and a second interface configured to couple a plurality of second waveguides of the photonic device to the plurality of waveguides of the atom trap device. A number of the plurality of first waveguides is smaller than a number of the plurality of second waveguides. A first pitch of the plurality of first waveguides is greater than a second pitch of the plurality of second waveguides.

Those skilled in the art will recognize additional features and advantages upon reading the following detailed description, and upon viewing the accompanying drawings.

### BRIEF DESCRIPTION OF THE DRAWINGS

The present disclosure is illustrated by way of example, and not by way of limitation, in the figures of the accompanying drawings in which like reference numerals refer to similar or identical elements. The elements of the drawings are not necessarily to scale relative to each other. The features of the various illustrated examples can be combined unless they exclude each other.

FIG. 1 schematically illustrates a diagram of a photonic device 100 in accordance with the disclosure.

FIG. 2 schematically illustrates a diagram of a system 200 in accordance with the disclosure.

FIG. 3 schematically illustrates a cross-sectional side view of a system 300 in accordance with the disclosure.

FIG. 4 schematically illustrates a diagram of a system 400 in accordance with the disclosure.

FIG. 5 schematically illustrates a diagram of a system 500 in accordance with the disclosure.

FIG. 6 schematically illustrates a cross-sectional side view of a connection between an atom trap device and a photonic device in accordance with the disclosure.

FIG. 7 schematically illustrates a cross-sectional side view of a connection between an atom trap device and a photonic device in accordance with the disclosure.

FIG. 8 schematically illustrates a cross-sectional side view of a connection between an atom trap device and a photonic device in accordance with the disclosure.

FIG. 9 schematically illustrates a cross-sectional side view of a connection between a light source and a photonic device in accordance with the disclosure.

FIG. 10 schematically illustrates a cross-sectional side view of a connection between a light source and a photonic device in accordance with the disclosure.

FIG. 11 schematically illustrates a cross-sectional side view of connections between a light source, an atom trap device and a photonic device in accordance with the disclosure.

FIG. 12 schematically illustrates a cross-sectional side view of connections between a light source, an atom trap device and a photonic device in accordance with the disclosure.

FIG. 13 schematically illustrates a perspective view of a connection between an atom trap device and a photonic device in accordance with the disclosure.

FIG. 14 schematically illustrates a perspective view of a connection between an atom trap device and a photonic device in accordance with the disclosure.

FIG. 15 schematically illustrates a side view of a connection between a light source and a photonic device in accordance with the disclosure.

FIG. 16 schematically illustrates a side view of a connection between a light source and a photonic device in accordance with the disclosure.

FIGS. 17A to 17C schematically illustrate cross-sectional side views of arrangements of waveguides included in a photonic device in accordance with the disclosure.

FIGS. 18A and 18B schematically illustrate cross-sectional side views of arrangements of waveguides included in a photonic device in accordance with the disclosure.

### DETAILED DESCRIPTION

The following description is directed to photonic devices which may be coupled to atom trap devices and further relates to systems including photonic devices and atom trap devices. In particular, the atom trap devices described in this context may correspond to ion trap devices which may be configured to trap ions (charged atoms or molecules) and to control the trapped ions. Atom trap devices may be implemented as atom trap chips in form of small, micro-fabricated devices configured to trap and manipulate individual atoms in a controlled manner. It is to be noted that the following description is not restricted to atoms, but may also be applied to ions, molecules or other quantum particles/systems (e.g. electrons or defect centers).

In some examples, atom trap devices as described herein may be used for quantum computing, but are not restricted thereto. Trapped atoms (in particular trapped ions) are one of the most promising candidates for being used as qubits in quantum computers, since they can be trapped with rather long lifetimes by means of electromagnetic fields. In this context, each atom may represent a physical qubit. However, atom trap devices are not restricted to the application of quantum computing. The atom trap devices described herein may also be used for other applications (such as atomic clocks).

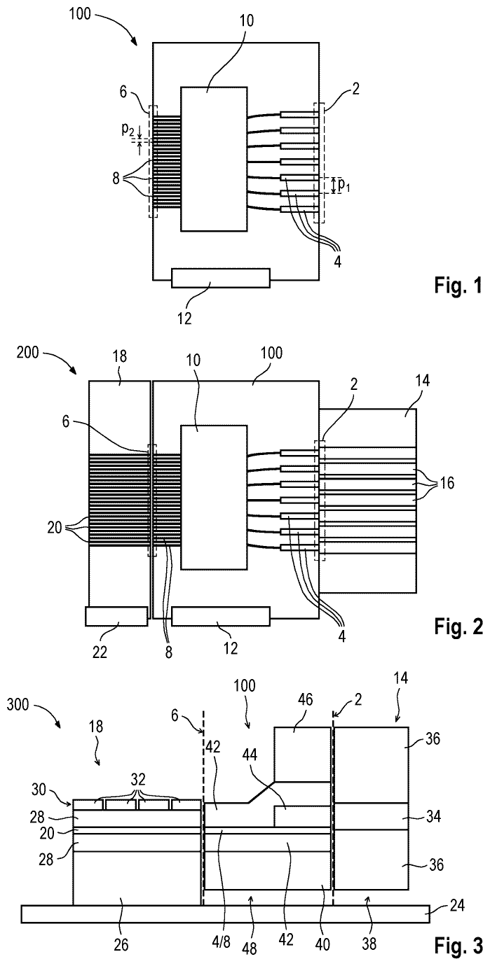

Referring now to FIG. 1, a diagram of a photonic device 100 in accordance with the disclosure is shown. The photonic device 100 may also be referred to as photonic chip or photonic accessory chip. The photonic device 100 may include a first interface 2 configured to couple a plurality of first waveguides 4 of the photonic device 100 to a plurality of waveguides of a light source (not illustrated). In addition, the photonic device 100 may include a second interface 6 configured to couple a plurality of second waveguides 8 of the photonic device 100 to a plurality of waveguides of an atom trap device (not illustrated). A number of the plurality of first waveguides 4 may be smaller than a number of the plurality of second waveguides 8. Furthermore, a first pitch p₁ of the plurality of first waveguides 4 may be greater than a second pitch p₂ of the plurality of second waveguides 8.

The first pitch p₁ and the second pitch p₂ between two neighboring waveguides may be specified as the distance between a center of one waveguide and the center of its neighboring waveguide as indicated in FIG. 1. The first pitch p₁ between two neighboring first waveguides 4 may be larger than about 100 μm. In specific, but non-limiting examples, the first pitch p₁ may be in a range between 100 μm and 300 μm, for example may have a value of about 127 μm or about 250 μm. The second pitch p₂ between two neighboring second waveguides 8 may be smaller than about 10 μm. Since p₁>p₂, the photonic device 100 may provide a reduction of waveguide pitches. In the illustrated example, the first pitch p₁ and the second pitch p₂ may be the same (or fixed) for all neighboring waveguides, respectively. However, it is to be understood that in further examples, one or both of the first pitch p₁ and the second pitch p₂ may vary for two or multiple neighboring waveguides. For example, the second pitch p₂ may have a variation of pitches in a range from about 3 μm to about 10 μm. In further examples, a first set of the first waveguides 4 (or the second waveguides 8) may have a specific pitch, while a second set of the first waveguides 4 (or the second waveguides 8) may have a different pitch.

The number of first waveguides 4 and second waveguides 8 as shown in the illustrated example is exemplary and in no way limiting. In general, a ratio of the number n₁ of the plurality of first waveguides 4 and the number n₂ of the plurality of second waveguides 8 (i.e. n₁/n₂) may be smaller than or equal to about 1/10. In a non-limiting example, the number n₁ of first waveguides 4 may be 10, and the number n₂ of second waveguides 8 may be 100 such that the ratio n₁/n₂ may equal 1/10. More general, the number n₁ of first waveguides 4 may be smaller than about 100, while the number n₂ of second waveguide 8 may be greater than about 100. Since n₁<n₂, the photonic device 100 may increase the number of waveguides between the first interface 2 and the second interface 6.

The first waveguides 4 and/or the second waveguides 8 may be configured to transmit electromagnetic waves having a wavelength in a range from about 350 nm to about 1800 nm. In particular, the first waveguides 4 and/or the second waveguides 8 may include or may correspond to optical waveguides. For example, the first waveguides 4 and/or the second waveguides 8 may correspond to or may include at least one of rectangular waveguides, rib waveguides, slot waveguides, photonic crystal waveguides, diffused waveguides, laser-written waveguides, or the like. The first waveguides 4 and/or the second waveguides 8 may include or may be made of at least one of silicon nitride, aluminum oxide, aluminum nitride, titanium oxide, lithium niobite, lithium tantalate, barium titanate, silicon, indium phosphate, polymer materials, or the like. The material of the waveguides may sometimes be referred to as a core material (or an active material) of the waveguides.

It is to be understood that dimensions of the waveguides 4 and/or 8 and the pitches between the waveguides 4 and/or 8 may particularly depend of a wavelength of the transmitted electromagnetic waves. For the case of rectangular waveguides having a cross-section of a height h and a width w, exemplary values are provided in the following Table 1. For the exemplary values, the waveguides are silicon nitride waveguides fully surrounded by silicon oxide cladding. The columns of Table 1 (from left to right) specify the wavelength λ in nm, the associated application (ion or band), the height h of the waveguide, the width w of the waveguide, a used mode of the waveguide, and a pitch p between neighboring waveguides in μm. The pitch p may lead to a crosstalk of −60 dB/100 μm in some examples. For the case of other geometries, such as a waveguide with a round cross-section, these values may differ.

| λ (nm) | Application | h (nm) | w (nm) | Mode | p (μm) |
|---|---|---|---|---|---|
| 369 | 171Yb+ | 100 | 120 | TE | 1.2 |
| 397 | 40Ca+ | 100 | 150 | TE | 1.3 |
| 422 | 88Sr+ | 150 | 180 | TE | 1.1 |
| 493 | Ba137+ | 150 | 200 | TE | 1.5 |
| 674 | 88Sr+ | 200 | 400 | TE | 1.9 |
| 729 | 40Ca+ | 200 | 450 | TE | 2.1 |
| 935 | Yb171+ | 200 | 700 | TE | 2.9 |
| 1092 | 88Sr+ | 350 | 450 | TE | 3.2 |
| 1310 | O band | 350 | 550 | TE | 4.2 |
| 1550 | C band | 350 | 600 | TE | 5.0 |
| 1762 | 137Ba+ | 350 | 700 | TE | 7.4 |

In the illustrated example of FIG. 1, the first interface 2 and the second interface 6 are indicated by dashed lines. For example, the first interface 2 may include at least one of spot size converters (SSC) or a grating structure. Exemplary implementations of the first interface 2 are shown and described in connection with FIGS. 9 and 10. The second interface 6 may e.g. include at least one of a grating structure or a taper structure. Exemplary implementations of the second interface 6 are shown and described in connection with FIGS. 6 to 8.

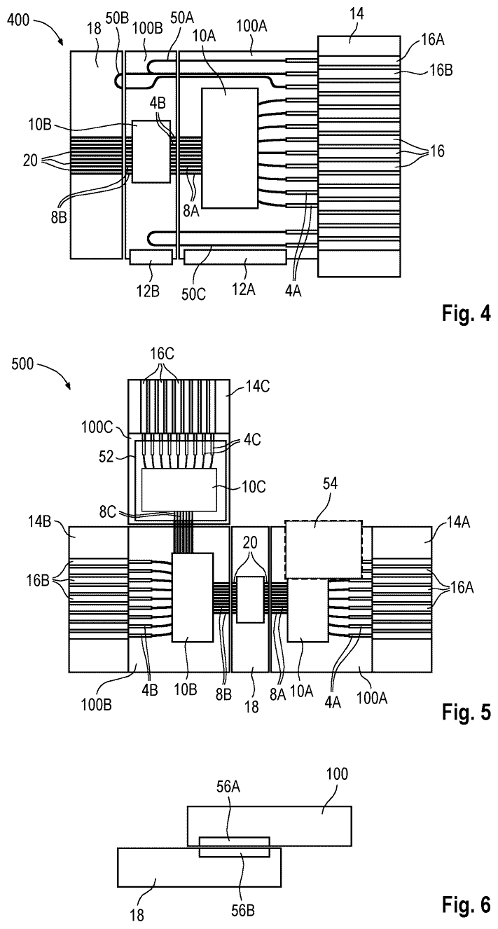

The photonic device 100 may include at least one active photonic component 10. In the shown case, the photonic device 100 may exemplarily include one active photonic component 10. However, it is to be understood that in further examples, photonic devices in accordance with the disclosure may include a plurality of active photonic components as e.g. shown in the examples of FIGS. 4 and 5. The active photonic component 10 may be configured to receive one or more electromagnetic waves (e.g. laser light) from a plurality of waveguides of a light source via the plurality of first waveguides 4. Further, the active photonic component 10 may be configured to process the received electromagnetic waves based on at least one control signal. The active photonic component 10 may be configured to output the processed electromagnetic waves to a plurality of waveguides of an atom trap device via the plurality of second waveguides 8. It is to be understood that (alternatively or additionally) an inverse process may be performed in which one or more electromagnetic waves may travel from the atom trap device to the photonic device 100 via the second interface 6, as well as the case where one or more electromagnetic waves may travel from the photonic device 100 into one or more fibers via the first interface 2.

The (at least one) active photonic component 10 may be configured to perform one or more operations on the electromagnetic waves received from the light source. More particular, the active photonic component 10 may be configured to perform at least one of splitting, tuning, detecting, switching, modulating, amplifying, attenuating, phase-changing, combining, filtering, polarization-changing, generation of a harmonic, generation of a supercontinuum, frequency up/down-converting, mixing of the electromagnetic waves received from the light source. For this purpose, the active photonic component 10 may include one or multiple active photonic elements to perform these operations. As a result, besides reducing a pitch and increasing a number of waveguides as previously described, the photonic device 100 may also be configured to process electromagnetic waves received from the light source and output the processed electromagnetic waves to the atom trap device.

The control signal provided to the active photonic component 10 may be configured to control the above mentioned operations performed by the active photonic component 10. In a first case, the control signal may include or may correspond to e.g. a radio frequency (RF) signal. Here, the control signal may be provided by a controller or control chip (not illustrated) which may be electrically coupled to the active photonic component 10 via one or more electrical contacts (or contact pads) 12 that may be arranged at a periphery of the photonic device 100. For example, the controller may include or may correspond to an ASIC. In a second case, the control signal may include or may correspond to an optical signal which may e.g. be provided via one or more of the first waveguides 4, for example from the light source. The optical signal may be encoded and/or multiplexed over one or very few waveguides of the light source. In yet other embodiments, the control signal may be a digital or analog electrical signal provided by a controller.

Referring now to FIG. 2, a diagram of a system 200 in accordance with the disclosure is shown. The system 200 may include a light source 14 having a plurality of waveguides 16, an atom trap device 18 having a plurality of waveguides 20, and a photonic device 100. The photonic device 100 may include some or all features of the photonic device 100 of FIG. 1 as previously described. The plurality of first waveguides 4 of the photonic device 100 may be coupled to the plurality of waveguides 16 of the light source 14 via the first interface 2 of the photonic device 100. More particular, a respective one of the first waveguides 4 may be connected to a respective one of the waveguides 16. In addition, the plurality of second waveguides 8 of the photonic device 100 may be coupled to the plurality of waveguides 20 of the atom trap device 18 via the second interface 6 of the photonic device 100. More particular, a respective one of the second waveguides 8 may be connected to a respective one of the waveguides 20.

In one example, the light source 14 may include or may correspond to at least one fiber array, and the plurality of waveguides 16 may correspond to a plurality of optical fibers of the fiber array. The optical fibers of the fiber array may be connected to the waveguides 4 of the photonic device 100 via the first interface 2. The atom trap device 18 may be implemented as an atom trap chip in form of a small, micro-fabricated device configured to trap and manipulate individual atoms in a controlled manner. In particular, the atom trap device 18 may be an ion trap device (or ion trap chip). The atom trap device 18 may include one or more electrical contacts 22 for electronic access. A more detailed structure of an exemplary fiber array and atom trap device included in a system in accordance with the disclosure is shown and described in connection with FIG. 3.

For enabling applications of practical interest, the atom trap device 18 may need to be scaled up to a large numbers of trapped atoms (or ions). Such scaling may require appropriate integration of photonics for laser light delivery. For example, in some applications, at least four laser beams per trapping site may be required in order to control dozens or hundreds of atoms independently. That is, when scaling the atom trap device 18 to larger dimensions, an increasing number of laser beams may become a major challenge in terms of optical access to the atom trap device 18. Furthermore, the number of fiber inputs may increase very quickly, and in addition to waveguides for routing and gratings for coupling out, other photonic elements for splitting, modulating and efficient fiber-to-chip coupling may be necessary.

The photonic device 100 may provide a solution to overcome and solve the aforementioned issues. The photonic device 100 may represent a dedicated photonic interface between the light source 14 and the atom trap device 18, wherein some or even all photonic functionalities may be separated from the atom trap device 18 and combined in the photonic device 100. A compact separation of suitable photonics for e.g. laser light delivery may thus be achieved. The photonic device 100 may enable an efficient in-coupling from the light source 14 (such as e.g. optical fibers) to the atom trap device 18 by means of a suitable mode conversion provided at the interfaces 2 and 6. In addition, as previously described in connection with FIG. 1, the number of waveguides at the output interface 6 may be increased compared to the number of waveguides at the input interface 2. Due to such increase of waveguides, the number of laser beams provided to the atom trap device 18 for controlling trapped atoms may be increased as well. A scaling of the atom trap device 18 to a large numbers of trapped atoms may thus be supported in an easy and straightforward way.

Referring now to FIG. 3, a cross-sectional side view of a system 300 in accordance with some aspects of the disclosure is shown. The system 300 may include some or all features of previously described examples. In particular, FIG. 3 may be seen as a cross section of FIG. 2. The system 300 may include an atom trap device 18, a photonic device 100 in accordance with the disclosure and a light source 14 which may be arranged above a carrier substrate 24. For example, the carrier substrate 24 may include or may correspond to a PCB, an interposer chip, or the like. A first interface 2 between the photonic device 100 and the light source 14 and a second interface 6 between the photonic device 100 and the atom trap device 18 are indicated by dashed vertical lines.

The atom trap device 18 may include a substrate 26 which may include or may be made of at least one of silicon, silicon carbide, fused silica, sapphire, glass, aluminum nitride, diamond. The atom trap device 18 may be mounted on the top surface of the carrier substrate 24. A dimension of the substrate 26 in the vertical direction may, for example, be in a range from about 200 μm to about 800 μm. The atom trap device 18 may further include a dielectric material 28 arranged above the top surface of the substrate 26 and a plurality of waveguides 20 embedded in the dielectric material 28. The dielectric material 28 may be configured as a surrounding medium or cladding material for the waveguides 20. For example, the dielectric material 28 may include or may correspond to an oxide, while the waveguides 20 may include or may be made of materials as described in connection with previous examples. In the specific cross-sectional side view of FIG. 3, only one waveguide 20 is shown for the sake of simplicity. However, it is to be understood that the atom trap device 18 may include multiple waveguides 20 as e.g. shown in FIG. 2. A dimension of the dielectric material 28 in the vertical direction may, for example, be in a range from about 3 μm to about 10 μm or more.

The atom trap device 18 may include a structured metal layer 30 arranged above the dielectric material 28. The structured metal layer 30 may form a plurality of electrodes 32 of the atom trap device 18 such that the structured metal layer 30 may also be referred to as structured electrode layer. For example, the structured metal layer 30 may include or may be made of a metal, coated metal or a metal alloy, such as e.g. at least one of aluminum, copper, gold or alloys thereof. The structured metal layer 30 (or the electrodes 32) may be configured to generate at least one of a magnetic, electric or electromagnetic field for trapping and/or controlling atoms (or ions) in a zone above the structured metal layer 30. Atoms trapped in or by the atom trap device 18 may be shuttled (or transported) along shuttling paths of the atom trap device 18. For example, the shuttling paths may extend above the structured metal layer 30 including the electrodes 32. In particular, a shuttling path may be arranged in a plane over (and in particular parallel to) the structured electrode layer 30. Time-dependent electric fields may be used for shuttling atoms along the shuttling paths. A shuttling of atoms may be controlled by electric voltages applied to the electrodes 32. In this context, the atom trap device 18 may further include at least one unit (not illustrated) configured to control the electric voltages applied to the electrodes 32, such as e.g. a controller or control chip.

In some examples, the trapped atoms can be moved along shuttling paths by means of AC and DC voltages that may be separately coupled to specific electrodes 32 of the structured metal layer 30. For example, the electrodes 32 may include RF electrodes for RF trapping and DC electrodes for static electric-field trapping and/or for moving the atoms (or ions) within the atom trap device 18. As another example, atoms may be confined by the combination of an external magnetic field and electrostatic quadrupole fields generated by voltages applied to DC electrodes. Atom trap devices as described herein may be configured to trap a plurality of atoms that may be individually addressable and movable by appropriately controlling the electric potentials of the electrodes 32. In one specific, but non-limiting example, atom trap devices as described herein may correspond to or may include a surface ion trap (or surface-electrode ion trap).

It is to be understood that the atom trap device 18 may include additional elements or additional material layers that may be arranged between the top surface of the substrate 26 and the structured metal layer 30 which are not shown here for the sake of simplicity. For example, an electrical redistribution layer may be included which may allow for a formation of complex electrode structures and insular electrodes in the structured electrode layer 30. Such electrical redistribution layer may also be configured to electrically connect the electrodes 32 to external circuitry such as a controller or control chip. Alternatively, or additionally, current carrying wires arranged in one or more metal layers beneath the structured electrode layer 30 may be provided, wherein the wires may be configured to generate a magnetic field gradient in a trapping zone above the electrodes 32 when carrying electrical currents.

The light source 14 may be any suitable component including a plurality of waveguides and being compatible with the first interface 2. In the illustrated example, the light source 14 may include or may correspond to a fiber array (or optical fiber array) including a plurality of fibers (or optical fibers or fiber cores or optical fiber cores) 34. In particular, the fibers 34 may correspond to the waveguides 16 of previous examples. The light source 14 may include a glass material 36, such as a glass wafer, a glass block, a glass plug, or the like, wherein the fibers 34 may be embedded in the glass material 36. A dimension of the glass material 36 in the vertical direction may, for example, be in a range from about 0.5 mm to about 5 mm. In a specific, but non-limiting example, the fiber array may include or may correspond to a V-groove array that may include a plurality of V-shaped grooves or channels. These grooves or channels may be machined into the glass material 36. The grooves or channels may be designed and configured to hold and align multiple optical fibers in a fixed position. In the illustrated example, the light source 14 may be attached (e.g. glued) to a side surface of the photonic device 100 and may be spaced apart from the carrier substrate 24. This way, mechanical stress at a mechanical interface between the photonic device 100 and the light source 14 may be reduced or avoided. When measured in the vertical direction, a dimension of a gap 38 between the top surface of the carrier substrate 24 and the bottom surface of the glass material 36 may be in a range from about 10 μm to about 500 μm. In further examples, the light source 14 is not necessarily separated from the carrier substrate 24, but may be mechanically connected to the top surface of the carrier substrate 24.

The photonic device 100 may include a substrate 40 which may include or may be made of at least one of silicon, silicon carbide, fused silica, sapphire, glass, aluminum nitride, diamond. The substrate 40 of the photonic device 100 and the substrate 26 of the atom trap device 18 may be made of the same material or of different materials. The photonic device 100 may further include a dielectric material 42 arranged above the top surface of the substrate 40 and a plurality of waveguides 4 and/or 8 embedded in the dielectric material 42. The waveguides 4 and/or 8 may correspond to the waveguides 4 and/or 8 described in connection with FIGS. 1 and 2. The dielectric material 42 may be configured as a surrounding medium or cladding material for the waveguides 4 and/or 8. For example, the dielectric material 42 may include or may correspond to an oxide, while the waveguides 4 and/or 8 may include or may be made of materials as described in connection with previous examples. In the specific cross-sectional side view of FIG. 3, only one waveguide 4 and/or 8 is shown for the sake of simplicity. However, it is to be understood that the photonic device 100 may include multiple waveguides 4 and/or 8 as e.g. shown in the examples of FIGS. 1 and 2. Furthermore, it is to be noted that in the cross-sectional side view of FIG. 3 an active photonic component of the photonic device 100 is not illustrated for the sake of simplicity. However, it is to be understood that the photonic device 100 may include one or multiple of such active photonic components configured to perform operations as described in connection with previous examples.

In the illustrated example, a thickness of the dielectric material 42 measured in the vertical direction may increase in a direction towards the light source 14. This way, an area of the right side surface of the photonic device 100 may be increased such that a stable mechanical connection between the photonic device 100 and the light source 14 may be established. In this context, the photonic device 100 may further include a material block 46 which may be arranged on the top surface of the dielectric material 42. For example, the material block 46 may include or may be made of a glass material, such as a glass wafer, a glass block, a glass plug, or the like. In a specific, but non-limiting example, the material block 46 may be a waferbonded glass block. The material block 46 may form a part of the side surface of the photonic device 100, wherein the side surface may be configured to be mechanically connected to the light source 14. The material block 46 may provide mechanical stability and ease a mechanical connection between the photonic device 100 and the light source 14.

The photonic device 100 may include spot size converters (SSC) 44 that may form a part of the first interface 2 between the photonic device 100 and the light source 14. The SSC 44 may be configured to switch or transition between different modes of the waveguides 4 of the photonic device 100 and the fibers 34 of the light source 14. An SSC 44 may be configured to convert the beam size (or spot size) of light emitted from a fiber 34 of the light source 14 to match the spot size of a waveguide 4 of the photonic device 100 and vice versa. Such conversion may optimize signal coupling and minimize loss during light transmission. In the illustrated example, the SSC 44 may be at least partially embedded in the dielectric material 42. The SSC 44 may be in contact with corresponding waveguides 4 of the photonic device 100.

The photonic device 100 may be attached (e.g. glued) to a side surface of the atom trap device 18 and may be spaced apart from the carrier substrate 24. This way, mechanical stress at a mechanical interface between the photonic device 100 and the atom trap device 18 may be reduced or avoided. When measured in the vertical direction, a dimension of a gap 48 between the top surface of the carrier substrate 24 and the bottom surface of the substrate 40 may be in a range from about 10 μm to about 500 μm. In further examples, the photonic device 100 is not necessarily separated from the carrier substrate 24, but may be mechanically connected to the top surface of the carrier substrate 24. It is to be noted that dimensions of the photonic device 100 may result from previously specified dimensions of the light source 14 and the atom trap device 18 and relative arrangements shown in FIG. 3.

During an operation of the system 300 electromagnetic waves may be coupled from the fibers 34 of the light source 14 into the waveguides 4 of the photonic device 100 at the first interface 2 via the SSC 44. In this regard, the fibers 34 may be adequately aligned with the SSC 44. The electromagnetic waves may be transported to the second interface 6 via the waveguides 4 and 8. Here, the electromagnetic waves may be processed by one or more active photonic components of the photonic device 100 as described in connection with previous examples. The electromagnetic waves may be coupled into the waveguides 20 of the atom trap device 18 at the second interface 6. In this regard, the waveguides 8 of the photonic device 100 may be aligned with the waveguides 20 of the atom trap device 18. The electromagnetic waves may then be transported towards a trapping zone of the atom trap device 18 via the waveguides 20. For example, the electromagnetic waves may be coupled out to the trapping zone by means of a grating structure such that atoms trapped in the trapping zone may be manipulated by the electromagnetic waves.

Referring now to FIG. 4, a diagram of a system 400 in accordance with the disclosure is shown. The system 400 may include some or all features of previously described systems. In particular, the system 400 may include a light source 14, an atom trap device 18 and a first photonic device 100A which may be similar to corresponding components of previous examples. The system 400 may further include at least one second photonic device 100B arranged between the first photonic device 100A and the atom trap device 18. The second photonic device 100B may be at least partially similar to the photonic device 100A and may include similar components. The system 400 may thus include a plurality of photonic devices that might be attached to each other sequentially, serially or mixed. One or multiple of these photonic components may include active photonic components. The plurality of photonic components may be stacked over each other, arranged laterally next to each other, or both. Each of the photonic components 100A, 100B may be connected to other components (e.g. another photonic component, a control chip, etc.) via electrical contacts 12A, 12B that may be arranged at a periphery of the respective component.

The system 400 may include one or multiple alignment loops. In the illustrated example, the system 400 may include an exemplary and non-limiting number of three alignment loops 50A to 50C. An alignment loop may be formed by one or more waveguides that may be included in at least two neighboring components of the system 400. For example, the alignment loop 50A may include waveguides included in the first and second photonic devices 100A, 100B. The alignment loops may be used for properly aligning the photonic devices 100A, 100B to each other. If the photonic devices 100A, 100B are properly aligned, an optical or electrical signal injected into the alignment loop 50A via a first fiber 16A may pass the entire alignment loop 50A and reach a second fiber 16B of the light source 14. If no signal is received at the second fiber 16B, the photonic devices 100A, 100B are not properly aligned. In the illustrated example, two alignment loops 50A and 50C may be used for aligning the photonic devices 100A and 100B. In addition, a third alignment loop 50B may be used for properly aligning the atom trap device 18 with the photonic devices 100A, 100B. It is to be understood that similar alignment loops may be included in previously described devices and systems.

Referring now to FIG. 5, a diagram of a system 500 in accordance with the disclosure is shown. The system 500 may include some or all features of previously described systems. In the illustrated example, the system 500 may include three light sources 14A to 14C, three photonic components 100A to 100C and an atom trap device 18. The mentioned components may be arranged and coupled via various interfaces as indicated in FIG. 5. In the illustrated case, multiple photonic devices may be coupled to the atom trap device 18. More particular, the first photonic device 100A may be coupled to a first side surface of the atom trap device 18, while the second photonic device 100B may be coupled to a second side surface of the atom trap device 18. A use of multiple photonic devices may avoid or reduce a bow or warpage of the individual devices, and/or a modularity of the arrangement may be increased. In a similar fashion, multiple elements may be coupled to the second photonic device 100B. More particular, the second light source 14B may be coupled to a first side surface of the second photonic device 100B, the third photonic device 100C may be coupled to a second side surface of the second photonic device 100B, and the atom trap device 18 may be coupled to a third side surface of the second photonic device 100B. In some examples, components of the system 500 (such as e.g. the photonic components 100B and 100C) may be coupled by means of photonic wire bonds.

In the shown case, the third photonic device 100C may optionally include at least one metal cover 52 which may be (partially or fully) arranged above the first waveguides 4C and/or the second waveguides 8C of the third photonic device 100C. For illustrative purposes, the metal cover 52 is shown to be transparent in order to not obscure the waveguides 4C, 8C and the active photonic component 10C of the third photonic device 100C. In practice, the metal cover may be opaque. The metal cover 52 may be configured to electromagnetically and/or optically shield at least one of the first waveguides 4C, the second waveguides 8C or the active photonic component 10C. More particular, the metal cover 52 may be configured for a shielding of stray light, RF fields, surface charges, or the like. In this regard, an influence of stray charges on atoms or ions trapped in the atom trap device 18 may be avoided or reduced. It is to be understood that the other photonic components 100A, 100B may include at least one metal cover as well. Furthermore, the system 500 may optionally include one or more photonic components 54, such as e.g. a light source, photodiodes, single-photon avalanche diodes (SPAD), a laser source, or the like. The photonic component(s) 54 may be assembled on one or more of the photonic devices 100A to 100C.

Referring now to FIG. 6, an exemplary connection between an atom trap device 18 and a photonic device 100 in accordance with the disclosure is shown. That is, an example for the second interface 6 of previous examples is illustrated. In the shown case, the photonic device 100 may be stacked onto the atom trap device 18. The second interface of the photonic device 100 may include a first grating structure 56A configured to be coupled to a second grating structure 56B of the atom trap device 18. The grating structures 56A, 56B may be arranged at the ends of waveguides (not illustrated) of the photonic device 100 and the atom trap device 18, respectively. The grating structures 56A, 56B may be aligned with respect to each other so that they may at least partially overlap when viewed in the vertical direction.

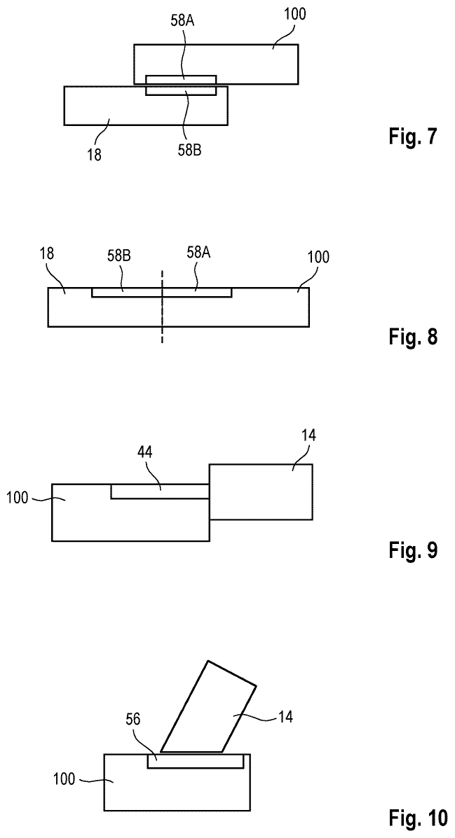

Referring now to FIG. 7, an exemplary connection between an atom trap device 18 and a photonic device 100 in accordance with the disclosure is shown. That is, an example for the second interface 6 of previous examples is illustrated. In the shown case, the photonic device 100 may be stacked onto the atom trap device 18. The second interface of the photonic device 100 may include a first taper structure 58A configured to be coupled to a second taper structure 58B of the atom trap device 18. The taper structures 58A, 58B may be arranged at the ends of waveguides (not illustrated) of the photonic device 100 and the atom trap device 18, respectively. The taper structures 58A, 58B may be aligned with respect to each other so that they may at least partially overlap when viewed in the vertical direction.

Referring now to FIG. 8, an exemplary connection between an atom trap device 18 and a photonic device 100 in accordance with the disclosure is shown. That is, an example for the second interface 6 of previous examples is illustrated. In the shown case, the atom trap device 18 may be arranged laterally next to the photonic device 100. The second interface of the photonic device 100 may include a first taper structure 58A configured to be coupled to a second taper structure 58B of the atom trap device 18. The taper structures 58A, 58B may be arranged at the ends of waveguides (not illustrated) of the photonic device 100 and the atom trap device 18, respectively. The taper structures 58A, 58B may be arranged at a substantially same height so that they may be at least partially aligned with respect to each other.

Referring now to FIG. 9, an exemplary connection between a light source 14 and a photonic device 100 in accordance with the disclosure is shown. That is, an example for the first interface 2 of previous examples is illustrated. In the shown case, the light source 14 may be arranged laterally next to the photonic device 100. The first interface of the photonic device 100 may include SSC 44 configured to be coupled to waveguides of the light source 14. The SSC 44 may be aligned with respect to waveguides of the light source 14 so that they may be at least partially arranged at a same height. The illustrated connection may be similar to the connection between the light source 14 and the photonic device 100 shown in the example of FIG. 3.

Referring now to FIG. 10, an exemplary connection between a light source 14 and a photonic device 100 in accordance with the disclosure is shown. That is, an example for the first interface 2 of previous examples is illustrated. In the shown case, the light source 14 may be stacked onto the photonic device 100. The first interface of the photonic device 100 may include a grating structure 56 configured to be coupled to waveguides of the light source 14. The grating structure 56 and waveguides of the light source 14 may be aligned with respect to each other so that they may at least partially overlap when viewed in the vertical direction.

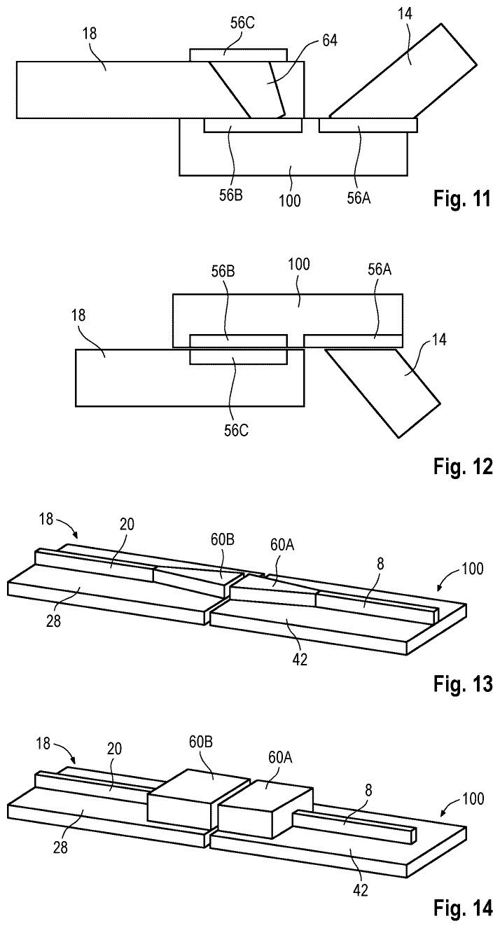

Referring now to FIG. 11, exemplary connections between a light source 14, an atom trap device 18 and a photonic device 100 in accordance with the disclosure are shown. In the illustrated example, the light source 14 and the atom trap device 18 may be stacked onto the photonic device 100. The photonic device 100 may include a first grating structure 56A and a second grating structure 56C. In the illustrated example, both grating structures 56A, 56B may be arranged at the top surface of the photonic device 100. The first grating structure 56A may be configured to couple electromagnetic waves (e.g. laser light) received from the light source 14 into the photonic device 100. The second grating structure 56B may be configured to couple out electromagnetic waves processed by one or more active photonic components of the photonic device 100 into the atom trap device 18. The electromagnetic waves coupled out by the second grating structure 56B may pass through the atom trap device 18 from its bottom surface to its top surface (see light field 64). The atom trap device 18 may include a third grating structure 56C configured to couple out electromagnetic waves received from the second grating structure 56B. For example, the electromagnetic waves may be coupled out to a trapping zone of the atom trap device 18.

Referring now to FIG. 12, exemplary connections between a light source 14, an atom trap device 18 and a photonic device 100 in accordance with the disclosure are shown. The system of FIG. 12 may include similar components as the system of FIG. 11, wherein the grating structures 56A and 56B of the photonic device 100 may now point downward. In the illustrated example, the second grating structure 56B of the photonic device 100 may be arranged directly opposite the third grating structure 56C of the atom trap device 18.

Referring now to FIG. 13, a connection between a waveguide 20 of an atom trap device 18 and a waveguide 8 of a photonic device 100 in accordance with the disclosure is illustrated. For the sake of simplicity, a respective cladding is only shown at the lower sides of the waveguides 8 and 20. A first mode converter 60A coupled to an end of the waveguide 8 may be aligned with a second mode converter 60B coupled to an end of the waveguide 20. The mode converters 60A and 60B may be configured for efficiently transitioning between different electromagnetic wave modes of the waveguides 8 and 20. The mode converters 60A and 60B may facilitate a conversion of electromagnetic waves from a mode of the waveguide 8 to a mode of the waveguide 20. In the illustrated example, the mode converters 60A and 60B may correspond to taper structures. That is, the arrangement of FIG. 13 may e.g. be similar to the previously described arrangement of FIG. 8. In the shown case, the taper structures may broaden in a direction towards each other. In further cases, the mode converters 60A and 60B may correspond to inverse taper structures.

Referring now to FIG. 14, a connection between a waveguide 20 of an atom trap device 18 and waveguide 8 of a photonic device 100 in accordance with the disclosure is shown. The illustrated arrangement may be similar to FIG. 13, but may differ in the implementation of the mode converters 60A and 60B. In the illustrated example, the mode converters 60A and 60B may correspond to secondary waveguides that may be larger than the waveguides 8 and 20. In a non-limiting example, a dimension of a mode converter 60A or 60B in a lateral direction may be in a range from about 500 μm to about 1000 μm, and a dimension in a vertical direction may be about 1 μm.

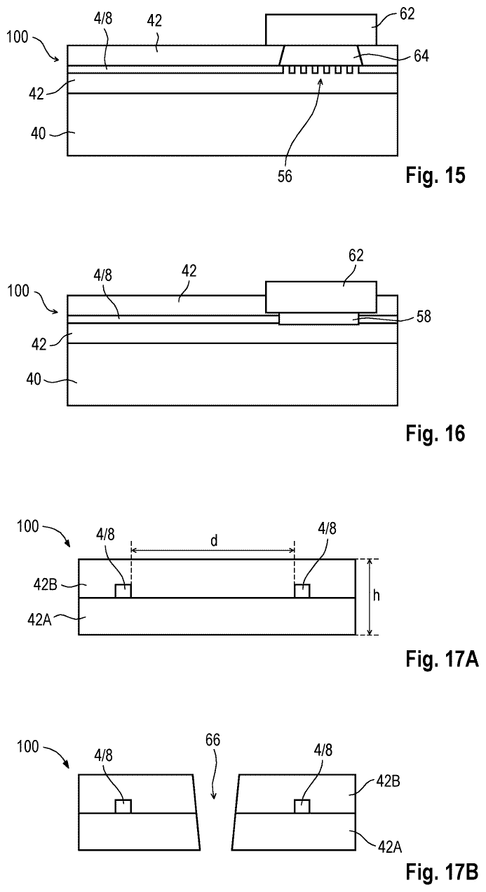

Referring now to FIG. 15, a connection between a photonic component 62 and a photonic device 100 in accordance with the disclosure is shown. For example, the photonic component 62 may include or may correspond to one of a vertical cavity surface emitting laser (VCSEL), a SPAD, a photodiode, or the like. Referring back to the example of FIG. 5, the photonic component 62 may be part of or may correspond to the photonic component 54. The photonic component 62 may be configured to generate or detect a light field 64 which may be convergent, divergent, collimated, or angled, depending on the specific case. In one example, electromagnetic waves generated by the photonic component 62 may pass through the oxide layer 42 and hit a grating structure 56 which may be at least partially formed in or at a waveguide 4 or 8 of the photonic device 100. The electromagnetic waves may be fed into the waveguide 4 or 8 via the grating structure 56. In another example, electromagnetic waves to be detected may propagate in the opposite direction towards the photonic component 62.

Referring now to FIG. 16, a connection between a photonic component 62 and a photonic device 100 in accordance with the disclosure is shown. The illustrated arrangement may be at least partially similar to FIG. 15. In the shown case, for example, electromagnetic waves generated by the photonic component 62 may be fed into a waveguide 4 or 8 via a taper structure 58, for example by means of evanescent coupling.

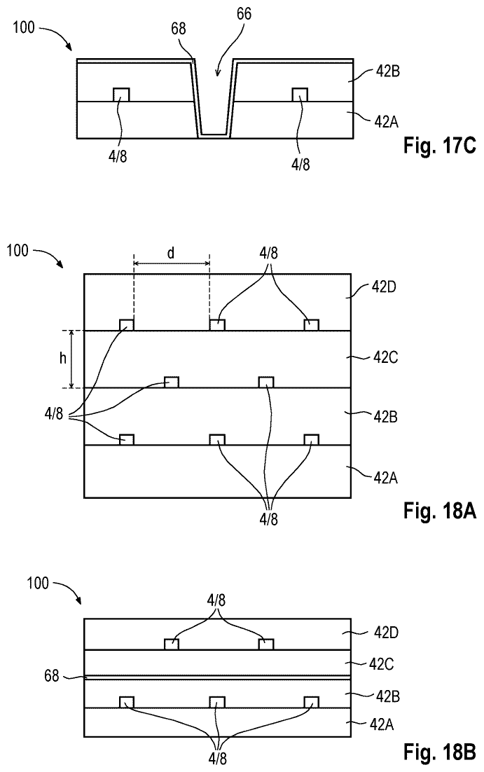

FIGS. 17A to 17C show cross-sectional side views of arrangements of waveguides 4 and/or 8 included in a photonic device 100 in accordance with the disclosure. In FIG. 17A, an exemplary number of two waveguides 4 and/or 8 may be embedded in a dielectric material 42 which may e.g. be formed by two stacked dielectric layers 42A and 42B. In particular, the waveguides 4 and/or 8 may be embedded in a dielectric material 42 having a lower (effective) refractive index for transmitted wavelengths. A distance d in the lateral direction between the two waveguides 4 and/or 8 and/or a height h of the two dielectric layers 42A, 42B in the vertical direction may be chosen such that an appropriate electromagnetic and/or optical isolation between the waveguides 4 and/or 8 may be provided. In a non-limiting example, the distance d may be smaller than about 10 μm, and the height h may be about 4 μm. In FIG. 17B, the waveguides 4 and/or 8 may be separated by at least one trench 66 formed in the dielectric material 42. The trench 66 may be configured to provide an electromagnetic and/or optical isolation between the waveguides 4 and/or 8. In FIG. 17C, surfaces of the trench 66 may be covered by a metal layer 68 which may be configured to further enhance the electromagnetic and/or optical shielding between the adjacent waveguides 4 and/or 8.

FIGS. 18A and 18B show cross-sectional side views of arrangements of waveguides 4 and/or 8 included in a photonic device 100 in accordance with the disclosure. In FIG. 18A, a plurality of waveguides 4 and/or 8 may be embedded in a dielectric material 42 which may e.g. be formed by a stack of multiple dielectric layers 42A to 42D. A distance d in the lateral direction between two neighboring waveguides 4 and/or 8 and/or a height h of a dielectric layer in the vertical direction may be chosen such that an appropriate electromagnetic and/or optical isolation between the waveguides 4 and/or 8 may be provided. In a non-limiting example, the distance d may be smaller than about 10 μm, and the height h may be smaller than about 10 μm. In FIG. 18B, at least one metal layer 68 may be arranged between the dielectric layers 42A to 42D. The metal layer 68 may be configured to electromagnetically and/or optically shield adjacent waveguides 4 and/or 8 embedded in different ones of the dielectric layers 42A to 42D.

The examples described herein provide photonic devices and systems including photonic devices.

Example 1 is a photonic device, comprising: a first interface configured to couple a plurality of first waveguides of the photonic device to a plurality of waveguides of a light source; and a second interface configured to couple a plurality of second waveguides of the photonic device to a plurality of waveguides of an atom trap device, wherein a number of the plurality of first waveguides is smaller than a number of the plurality of second waveguides, and wherein a first pitch of the plurality of first waveguides is greater than a second pitch of the plurality of second waveguides.

Example 2 is a photonic device of Example 1, further comprising: at least one active photonic component, the at least one active photonic component configured to: receive one or more electromagnetic waves from the plurality of waveguides of the light source via the plurality of first waveguides, process the received electromagnetic waves based on at least one control signal, and output the processed electromagnetic waves to the plurality of second waveguides.

Example 3 is a photonic device of Example 2, wherein the at least one active photonic component is configured to perform at least one of splitting, tuning, detecting, switching, modulating, amplifying, attenuating, phase-changing, combining, filtering, polarization-changing, generation of a harmonic, generation of a supercontinuum, frequency up/down-converting, mixing of the electromagnetic waves received from the light source.

Example 4 is a photonic device of any of the preceding Examples, wherein the first pitch is larger than 100 μm, and the second pitch is smaller than 10 μm.

Example 5 is a photonic device of any of the preceding Examples, wherein a ratio of the number of the plurality of first waveguides and the number of the plurality of second waveguides is smaller than 1/10.

Example 6 is a photonic device of any of the preceding Examples, wherein the first waveguides and/or the second waveguides are configured to transmit electromagnetic waves having a wavelength in a range from 350 nm to 1800 nm.

Example 7 is a photonic device of any of the preceding Examples, wherein the first waveguides and/or the second waveguides comprise at least one of silicon nitride, aluminum oxide, aluminum nitride, titanium oxide, lithium niobite, lithium tantalate, barium titanate, silicon, indium phosphate, polymer materials.

Example 8 is a photonic device of any of the preceding Examples, wherein the first waveguides and/or the second waveguides are embedded in a dielectric material and separated by trenches formed in the dielectric material.

Example 9 is a photonic device of Example 8, wherein surfaces of the trenches are covered by a metal layer configured to electromagnetically and/or optically shield adjacent waveguides.

Example 10 is a photonic device of any of the preceding Examples, wherein the first waveguides and/or the second waveguides are embedded in a stack of multiple dielectric layers.

Example 11 is a photonic device of Example 10, wherein metal layers are arranged between the multiple dielectric layers and configured to electromagnetically and/or optically shield adjacent waveguides embedded in different dielectric layers.

Example 12 is a photonic device of any of the preceding Examples, wherein the first interface comprises at least one of spot size converters or a grating structure.

Example 13 is a photonic device of any of the preceding Examples, wherein the first interface comprises spot size converters configured to be coupled to waveguides of a light source arranged laterally next to the photonic device.

Example 14 is a photonic device of any of the preceding Examples, wherein the first interface comprises a grating structure configured to be coupled to waveguides of a light source stacked onto the photonic device.

Example 15 is a photonic device of any of the preceding Examples, wherein the second interface comprises at least one of a grating structure or a taper structure.

Example 16 is a photonic device of any of the preceding Examples, wherein the second interface comprises a first taper structure configured to be coupled to a second taper structure of an atom trap device arranged laterally next to the photonic device.

Example 17 is a photonic device of any of the preceding Examples, wherein the second interface comprises at least one of a first grating structure or a first taper structure configured to be coupled to at least one of a second grating structure or a second taper structure of an atom trap device stacked onto the photonic device.

Example 18 is a photonic device of any of the preceding Examples, further comprising: a material block forming a side surface of the photonic device, wherein the side surface is configured to be mechanically connected to a light source arranged laterally next to the photonic device.

Example 19 is a photonic device of any of the preceding Examples, further comprising: a metal cover arranged above the first waveguides and/or the second waveguides, wherein the metal cover is configured to electromagnetically and/or optically shield the first waveguides and/or the second waveguides.

Example 20 is a system, comprising: a light source comprising a plurality of waveguides; an atom trap device comprising a plurality of waveguides; and a first photonic device comprising: a first interface configured to couple a plurality of first waveguides of the photonic device to the plurality of waveguides of the light source, and a second interface configured to couple a plurality of second waveguides of the photonic device to the plurality of waveguides of the atom trap device, wherein a number of the plurality of first waveguides is smaller than a number of the plurality of second waveguides, and wherein a first pitch of the plurality of first waveguides is greater than a second pitch of the plurality of second waveguides.

Example 21 is a system of Example 20, wherein: the atom trap device is mounted on a carrier substrate, and the first photonic device is attached to a side surface of the atom trap device and spaced apart from the carrier substrate.

Example 22 is a system of Example 20 or 21, further comprising: at least one second photonic device arranged between the first photonic device and the atom trap device.

Example 23 is a system of Example 20 or 21, further comprising: at least one second photonic device, wherein the first photonic device is coupled to a first side surface of the atom trap device and the second photonic device is coupled to a second side surface of the atom trap device.

Example 24 is a system of any of Examples 20 to 23, further comprising: a photonic component assembled on the first photonic device.

As used in this specification, the terms “substantially”, “approximately”, “about”, or the like, may mean “within reasonable tolerances for manufacturing”. For example, the terms “substantially”, “approximately”, “about”, or the like, may be used herein to account for small manufacturing tolerances or other factors (e.g., within 5%) that are deemed acceptable in the industry without departing from the aspects of the examples described herein. For example, a material layer with an approximate thickness value may practically have a thickness within 5% of the approximate thickness value.

As used herein, the terms “electrically connected” or “electrically coupled” or similar terms are not meant to mean that the elements are directly contacted together; intervening elements may be provided between the “electrically connected” or “electrically coupled” elements, respectively. However, in accordance with the disclosure, the above-mentioned and similar terms may, optionally, also have the specific meaning that the elements are directly contacted together, i.e. that no intervening elements are provided between the “electrically connected” or “electrically coupled” elements, respectively.

The words “over”, “above”, “beneath”, or the like, with regard to a part, element or material layer formed or located or arranged “over”, “above” or “beneath” a surface may be used herein to mean that the part, element or material layer be located (e.g. placed, formed, arranged, deposited, etc.) “directly over”, “directly above” or “directly beneath”, e.g. in direct contact with, the implied surface. The words “over”, “above”, “beneath”, or the like, used with regard to a part, element or material layer formed or located or arranged “over”, “above” or “beneath” a surface may, however, either be used herein to mean that the part, element or material layer be located (e.g. placed, formed, arranged, deposited, etc.) “indirectly over”, “indirectly above” or “indirectly beneath” the implied surface, with one or more additional parts, elements or layers being arranged between the implied surface and the part, element or material layer.

Although specific examples have been illustrated and described herein, it will be appreciated by those of ordinary skill in the art that a variety of alternate and/or equivalent implementations may be substituted for the specific examples shown and described without departing from the scope of the present invention. This application is intended to cover any adaptations or variations of the specific examples discussed herein. Therefore, it is intended that this invention be limited only by the claims and the equivalents thereof.

It should be noted that the methods and devices including its preferred embodiments as outlined in the present document may be used stand-alone or in combination with the other methods and devices disclosed in this document. In addition, the features outlined in the context of a device are also applicable to a corresponding method, and vice versa. Furthermore, all aspects of the methods and devices outlined in the present document may be arbitrarily combined. In particular, the features of the claims may be combined with one another in an arbitrary manner.

It should be noted that the description and drawings merely illustrate the principles of the proposed methods and systems. Those skilled in the art will be able to implement various arrangements that, although not explicitly described or shown herein, embody the principles of the invention and are included within its spirit and scope. Furthermore, all examples and embodiments outlined in the present document are principally intended expressly to be only for explanatory purposes to help the reader in understanding the principles of the proposed methods and systems. Furthermore, all statements herein providing principles, aspects, and embodiments of the invention, as well as specific examples thereof, are intended to encompass equivalents thereof.

What is claimed is:

1. A photonic device, comprising:
a first interface configured to couple a plurality of first waveguides of the photonic device to a plurality of waveguides of a light source; and
a second interface configured to couple a plurality of second waveguides of the photonic device to a plurality of waveguides of an atom trap device,
wherein a number of the plurality of first waveguides is smaller than a number of the plurality of second waveguides,
wherein a first pitch of the plurality of first waveguides is greater than a second pitch of the plurality of second waveguides.

2. The photonic device of claim 1, further comprising:
at least one active photonic component configured to:
receive one or more electromagnetic waves from the plurality of waveguides of the light source via the plurality of first waveguides;
process the received electromagnetic waves based on at least one control signal; and
output the processed electromagnetic waves to the plurality of second waveguides.

3. The photonic device of claim 2, wherein the at least one active photonic component is configured to perform at least one of splitting, tuning, detecting, switching, modulating, amplifying, attenuating, phase-changing, combining, filtering, polarization-changing, generation of a harmonic, generation of a supercontinuum, frequency up/down-converting, and mixing of the electromagnetic waves received from the light source.

4. The photonic device of claim 1, wherein the first pitch is larger than 100 μm and the second pitch is smaller than 10 μm.

5. The photonic device of claim 1, wherein a ratio of the number of the plurality of first waveguides and the number of the plurality of second waveguides is smaller than 1/10.

6. The photonic device of claim 1, wherein the first waveguides and/or the second waveguides are configured to transmit electromagnetic waves having a wavelength in a range from 350 nm to 1800 nm.

7. The photonic device of claim 1, wherein the first waveguides and/or the second waveguides comprise at least one of silicon nitride, aluminum oxide, aluminum nitride, titanium oxide, lithium niobite, lithium tantalate, barium titanate, silicon, indium phosphate, and polymer materials.

8. The photonic device of claim 1, wherein the first waveguides and/or the second waveguides are embedded in a dielectric material and separated by a plurality of trenches formed in the dielectric material.

9. The photonic device of claim 8, wherein a plurality of surfaces of the trenches are covered by a metal layer configured to electromagnetically and/or optically shield adjacent waveguides.

10. The photonic device of claim 1, wherein the first waveguides and/or the second waveguides are embedded in a stack of multiple dielectric layers.

11. The photonic device of claim 10, wherein a plurality of metal layers is arranged between the multiple dielectric layers and configured to electromagnetically and/or optically shield adjacent waveguides embedded in different dielectric layers.

12. The photonic device of claim 1, wherein the first interface comprises at least one of a plurality of spot size converters or a grating structure.

13. The photonic device of claim 1, wherein the first interface comprises a plurality of spot size converters configured to be coupled to waveguides of the light source arranged laterally next to the photonic device.

14. The photonic device of claim 1, wherein the first interface comprises a grating structure configured to be coupled to a plurality of waveguides of the light source stacked onto the photonic device.

15. The photonic device of claim 1, wherein the second interface comprises at least one of a grating structure or a taper structure.

16. The photonic device of claim 1, wherein the second interface comprises a first taper structure configured to be coupled to a second taper structure of the atom trap device arranged laterally next to the photonic device.

17. The photonic device of claim 1, wherein the second interface comprises at least one of a first grating structure or a first taper structure configured to be coupled to at least one of a second grating structure or a second taper structure of the atom trap device stacked onto the photonic device.

18. The photonic device of claim 1, further comprising:
a material block forming a side surface of the photonic device,
wherein the side surface is configured to be mechanically connected to the light source arranged laterally next to the photonic device.

19. The photonic device of claim 1, further comprising:
a metal cover arranged above the first waveguides and/or the second waveguides,
wherein the metal cover is configured to electromagnetically and/or optically shield the first waveguides and/or the second waveguides.

20. A system, comprising:
a light source comprising a plurality of waveguides;
an atom trap device comprising a plurality of waveguides; and
a first photonic device comprising:
a first interface configured to couple a plurality of first waveguides of the photonic device to the plurality of waveguides of the light source; and
a second interface configured to couple a plurality of second waveguides of the photonic device to the plurality of waveguides of the atom trap device,
wherein a number of the plurality of first waveguides is smaller than a number of the plurality of second waveguides,
wherein a first pitch of the plurality of first waveguides is greater than a second pitch of the plurality of second waveguides.

21. The system of claim 20, wherein:
the atom trap device is mounted on a carrier substrate; and
the first photonic device is attached to a side surface of the atom trap device and spaced apart from the carrier substrate.

22. The system of claim 20 further comprising:
at least one second photonic device arranged between the first photonic device and the atom trap device.

23. The system of claim 20, further comprising:
at least one second photonic device,
wherein the first photonic device is coupled to a first side surface of the atom trap device and the second photonic device is coupled to a second side surface of the atom trap device.

24. The system of claim 20, further comprising:
a photonic component assembled on the first photonic device.
